(19) United States
(12) Patent Application Publication
(10) Pub. No.: US 2024/0162631 A1
(43) Pub. Date: May 16, 2024

(54) Connector Terminal, Connector Housing and Connector

(71) Applicants: TE Connectivity Germany GmbH, Bensheim (DE); Tyco Electronics (Shanghai) Co., Ltd., Shanghai (CN); TE Connectivity Italia Distribution S.r.l., Torino (IT)

(72) Inventors: Yongjia (Winter) Wang, Shanghai (CN); Federico Lupo, Torino (IT); Zhiyi Li, Shanghai (CN); Thomas Klenner, Bensheim (DE)

(73) Assignees: TE Connectivity Germany GmbH, Bensheim (DE); Tyco Electronics (Shanghai) Co., Ltd., Shanghai (CN); TE Connectivity Italia Distribution S.r.l., Torino (IT)

(21) Appl. No.: 18/509,675

(22) Filed: Nov. 15, 2023

(30) Foreign Application Priority Data
Nov. 15, 2022 (CN) 202211430803.1

(51) Int. Cl. H01R 4/2429; H01R 13/506

(52) U.S. Cl. CPC H01R 4/2429; H01R 13/506

(57) ABSTRACT

A connector terminal includes a clamping part and a contacting part. A side of a first end of the clamping part has a first barb structure and a pair of sides of a second end of the clamping part each have a second barb structure. The first end is opposite to the second end. The contacting part extends along a first direction from the second end of the clamping part and electrically contacts a terminal paired with the connector terminal.

### CROSS-REFERENCE TO RELATED APPLICATIONS

This application claims the benefit of the filing date under 35 U.S.C. § 119(a)-(d) of Chinese Patent Application No. 202211430803.1, filed on Nov. 15, 2022.

### FIELD OF THE DISCLOSURE

The present disclosure relates to the field of electronic connecting parts and, in particular, to a connector terminal, a connector housing, and a connector.

### BACKGROUND

FIG. 1a shows an exploded structural view of an existing connector, FIG. 1b shows a perspective view of the existing connector coupled with cables, and FIG. 1c shows a sectional view of the existing connector. Specifically, the existing connector includes: a connector terminal 12, a body 13 and an end cap 11. As shown in FIG. 1a, a clamping part 121 of the connector terminal 12 is provided with a barb structure 122 only at a position close to a contacting part 123. The end cap 11 includes a guide groove 111. The top of guide groove 111 further includes a groove 1112 extending in a direction perpendicular to an insertion direction of the cables and an insertion direction of the connector terminal 12, so that a guide part 131 of the body 13 can fit closely with the guide groove 111 and the groove 1112.

In actual use, the connector terminal 12 is first installed into the body 13 so that the barb structure 122 of the connector terminal 12 has an interference fit with the body 13, and then the end cap 11 is pre-assembled to the body 13. Then, in the step of crimping the cables 14, it is only required to insert the cables 14 into the holes in the end cap 11, and then push the end cap 11 toward the body 13 to form crimping for the terminal, which is very efficient.

As shown in FIGS. 1b and 1c, when the body 13 is closely fitted with the end cap 11, the guide part 131 of the body 13 is snapped into the guide groove 111 and the groove 1112, and the snapping part 133 of the body 13 is closely fitted with the snapping fitting part 112 of the end cap 11, thereby achieving a close fit between the connector terminal 12 and the connector housing. The prior art is relatively effective for a connector with a relatively large size. However, for some very small connectors, there is not enough space on the end cap to accommodate the groove 1112, making it difficult to pre-assemble the end cap with the body and the connector terminal.

### SUMMARY

A connector terminal includes a clamping part and a contacting part. A side of a first end of the clamping part has a first barb structure and a pair of sides of a second end of the clamping part each have a second barb structure. The first end is opposite to the second end. The contacting part extends along a first direction from the second end of the clamping part and electrically contacts a terminal paired with the connector terminal.

### BRIEF DESCRIPTION OF THE DRAWINGS

Features of the present invention will become more apparent by describing in detail exemplary embodiments thereof with reference to the accompanying drawings, in which:

FIG. 1a is a schematic exploded structural view of an existing connector including a connector housing and a connector terminal;

FIG. 1b is a schematic perspective view of the existing connector coupled with cables;

FIG. 1c is a sectional view of the existing connector;

FIG. 2 is a schematic exploded structural view of a connector including a connector housing and a connector terminal, according to the present disclosure;

FIG. 3a is a schematic perspective view of a connector according to the present disclosure;

FIG. 3b is another schematic perspective view of the connector of FIG. 3a with cables;

FIG. 3c is another schematic perspective view of the connector of FIG. 3a;

FIG. 4 is a schematic perspective view of a connector terminal according to the present disclosure;

FIG. 5 is a schematic sectional view of the connector according to the present disclosure, wherein the cables are not coupled to the connector; and

FIG. 6 is another sectional view of the connector according to the present disclosure, wherein the cables are coupled to the connector.

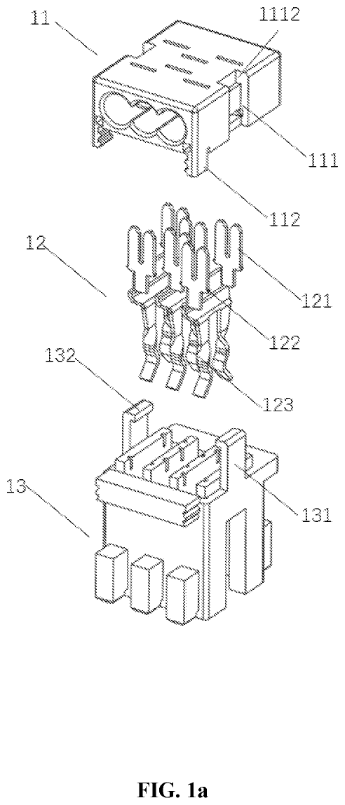

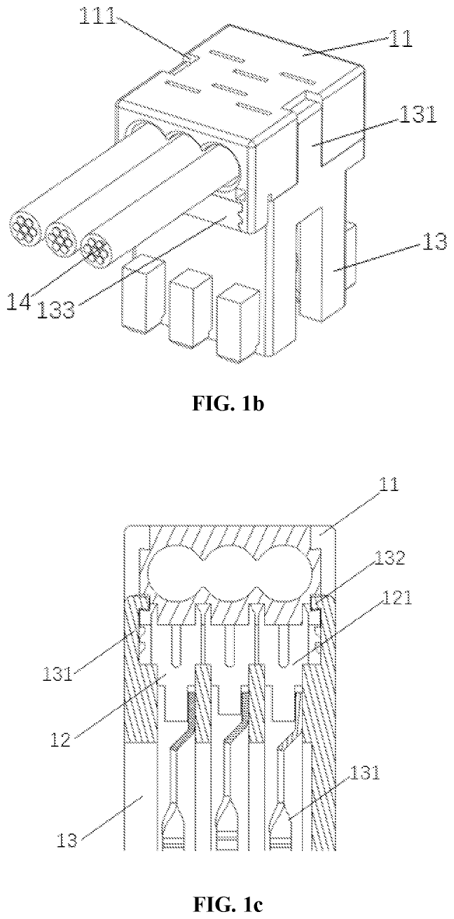

### DETAILED DESCRIPTION OF EXEMPLARY EMBODIMENTS

The technical solution of the present disclosure is described in detail below through the following embodiments and in conjunction with the accompanying drawings. The same or similar reference numerals throughout the description indicate the same or similar components. The following description of the embodiments of the present disclosure with reference to the accompanying drawings is intended to explain the overall inventive concept of the present disclosure and should not be construed as a limitation on the present disclosure.

The terms “includes”, “comprises” and the like used in the present disclosure should be interpreted as open-ended terms, i.e., “includes/comprises but is not limited to”, indicating that other elements may also be included. The term “based on” indicates “based at least in part on”. The term “one embodiment” indicates “at least one embodiment”. The term “another embodiment” indicates “at least one additional embodiment”.

The present disclosure mainly focuses on the following technical problem: how to optimize the connector without modifying the parameters and dimensions of the socket terminal in order to improve the stability of transmission of the connector.

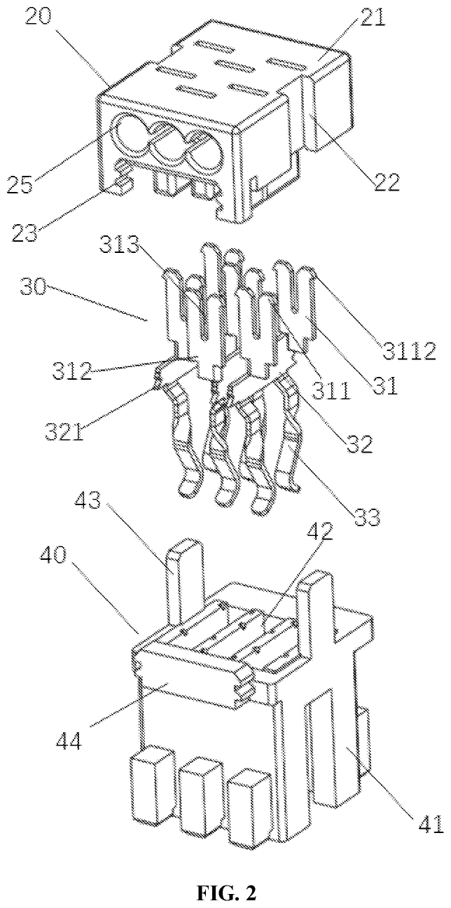

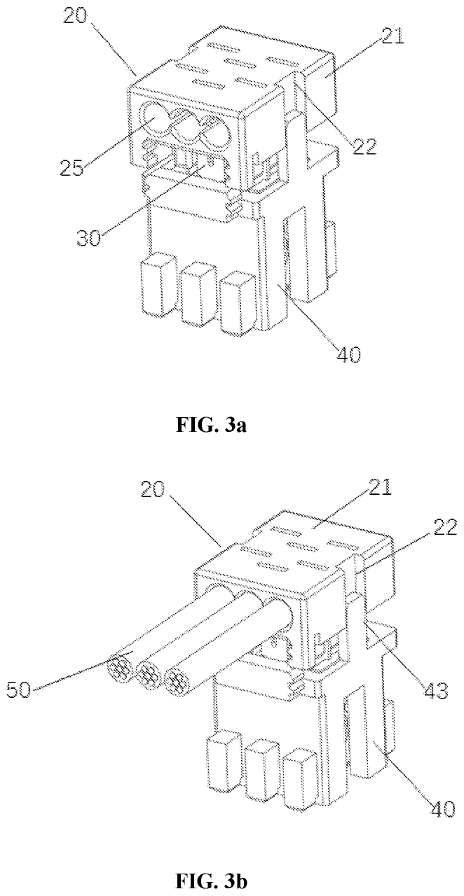

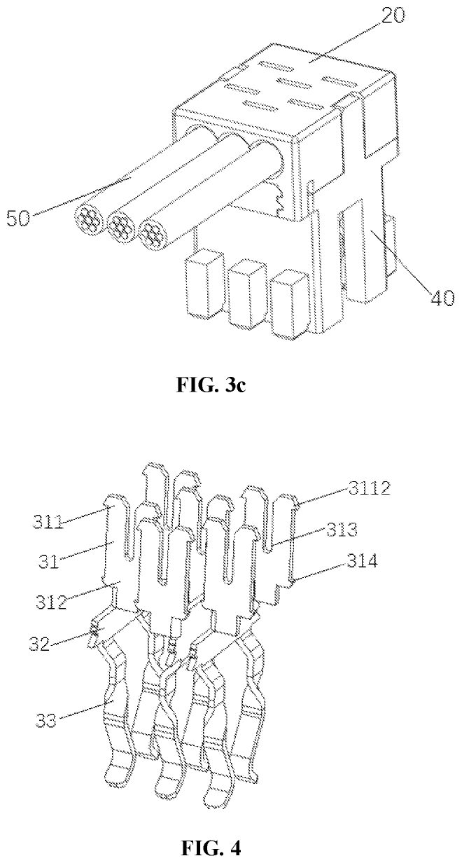

FIGS. 2 to 3c show an example of the connector according to the present disclosure. The connector includes a connector housing and a connector terminal 30 arranged in the connector housing. In this example, the connector terminal 30 includes a clamping part 31, a connecting part 32, and a contacting part 33, as shown in FIG. 2. Specifically, a second end 312 of the clamping part 31 is coupled to the connecting part 32, and the connecting part 32 is coupled to the contacting part 33.

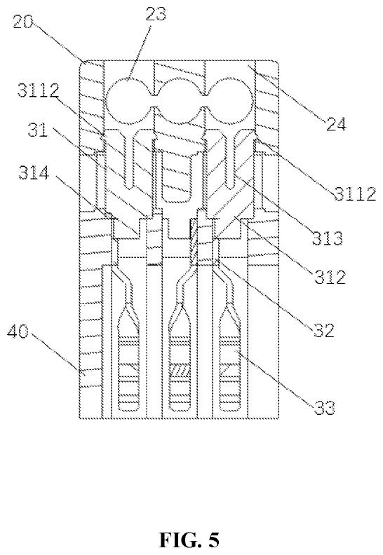

As shown in FIG. 2, at least one side of a first end 311 of the clamping part 31 is provided with a first barb structure 3112. At least one end of the connecting part 32 is provided with a second barb structure 321 along a second direction. The contacting part 33 extends along the first direction F1 (as shown in FIG. 5) and is configured for electrically contacting a terminal paired with the connector terminal 30.

In addition, the clamping part 31 is further provided with a slot 313, as shown in FIG. 2. The slot 313 has a blade-type inner wall used for piercing an insulating casing of the cable, so as to achieve electrical connection between the cable and the connector terminal 30.

Further, the first end 311 of the clamping part 31 forms two first barb structures 3112, respectively, as shown in FIGS. 2, 5 and 6. A cross section of each first barb structure 3112 in a direction perpendicular to the first direction F1 is triangular, so that the width of the first end 311 of the clamping part 31 is greater than the width of a first snapping groove 24 of the connector housing fitting with the connector terminal 30.

In this example, a cross section of the second barb structure 321 in another direction (for example, a direction perpendicular to the paper surface as shown in FIG. 2) perpendicular to the first direction F1 is triangular, so that the width of the connecting part 32 in this direction is greater than the width of a second snapping groove 42 of the connector housing fitting with the connector terminal 30.

Furthermore, in actual use, the one or more first barb structures 3112 of the first end 311 of the clamping part 31 may be multiple triangles arranged along the first direction F1, that is, the first barb structure 3112 is serrated.

In this example, one side of the first barb structure 3112 extends obliquely from the top of the first end 311 of the clamping part 31 along a first angle. Specifically, the first angle refers to an angle between the side of the first barb structure 3112 and the first direction F1, and has an angle range of 15° to 45°.

Further, in this example, one side of the second barb structure 321 extends obliquely from one end of the connecting part 32 along a second angle. Specifically, the second angle refers to an angle between the side of the second barb structure 321 and the first direction F1, and has an angle range of 15° to 45°.

In this example, two sides of the first end 311 of the connector terminal 30 are respectively provided with the first barb structures 3112, as shown in FIG. 2. However, it is also applicable in actual use that only one side of the first end 311 is provided with the first barb structure 3112 as needed, or two sides of the first end 311 of the connector terminal 30 may be respectively provided with the first barb structures 3112 of different shapes as needed (for example, one side of the first end 311 of the connector terminal 30 is provided with the first barb structure 3112 having a triangular cross section, and the other side of the first end 311 of the connector terminal 30 is provided with the first barb structure 3112 having a serrated cross section).

In this example, the body 40 of the connector housing includes a first housing 41, a pair of guide parts 43, and a snapping part 44, as shown in FIG. 2. The first housing 41 is internally provided with one or more second snapping grooves 42. The pair of guide parts 43 respectively extends from opposite sides of the first housing in a second direction opposite to the first direction F1. The snapping part 44 is arranged on a third side of the first housing 41. Specifically, the third side is adjacent to sides where the pair of guide parts 43 is located.

In this example, an end cap 20 of the connector housing includes a second housing 21, a pair of guide grooves 22, and a pair of snapping fitting parts 23, as shown in FIG. 2. The second housing 21 is internally provided with one or more first snapping grooves 24 (as shown in FIG. 5). The pair of guide grooves 22 is respectively arranged on two opposite sides of the second housing 21 so that the pair of guide grooves 22 fits with the pair of guide parts 43. The pair of snapping fitting parts 23 is respectively arranged at lower ends of the two opposite sides of the second housing 21 so that the pair of snapping fitting parts 23 firmly fits with the snapping part 44.

Further, as shown in FIGS. 2, 5 and 6, the second housing 21 is internally provided with one or more cable grooves 25 for accommodating cables 50 electrically connected with the connector terminal 30.

FIGS. 3a to 3c show the installation and matching process of the connector disclosed herein. In this example, the connector terminal 30 is first inserted into the body 40 of the connector housing so that the second barb structure 321 of each connector terminal 30 has an interference fit with the second snapping groove 42 of the body 40, thereby ensuring a firm fit between the connector terminal 30 and the body 40. Then, the end cap 20 is pre-assembled with the body 40 so that the pair of guide parts 43 of the body 40 fits with the pair of guide grooves 22 of the end cap 20, to ensure the correct matching of the two during installation. At the same time, the first barb structure 3112 of the clamping part 31 of the connector terminal 30 which is inserted into the body 40 has an interference fit with the corresponding first snapping groove 24.

Then, as shown in FIG. 3b, the cables 50 are inserted into the cable grooves 25. Finally, as shown in FIG. 3c, the end cap 20 is completely fitted with the body 40 so that the pair of guide grooves 22 of the end cap 20 fully fits with the pair of guide parts 43 of the body 40, and the pair of snapping fitting parts 23 of the end cap 20 fits with the snapping part 44 of the body 40. The top end of the first barb structure 3112 of the clamping part 31 of the connector terminal 30 provides a guiding effect for relative movement between the first barb structure 3112 and the inner wall of the corresponding first snapping groove 24, so that the clamping part 31 can successfully and fully fit with the corresponding first snapping groove 24. At the same time, the cables 50 are clamped in the slots 312 of the clamping parts 31 of the connector terminal 30 to ensure the electrical connection between the cables 50 and the connector terminal 30.

Thus, the connector terminal 30 is closely fitted with the body 40 and the end cap 20 by means of the first barb structure 3112 and the second barb structure 321, and the body 40 and the end cap 20 are also closely fitted with each other by means of the first barb structure 3112 and the second barb structure 321.

In the connector disclosed in the present example, the first barb structure of the connector terminal improves the retention force between the end cap and the connector terminal, and the second barb structure of the connector terminal also improves the retention force between the body and the connector terminal. Meanwhile, pre-assembly of the connector terminal, the end cap and the body can be achieved, avoiding the problem that the end cap detaches from the body in actual use.

FIGS. 4 to 6 show another example of the connector according to the present disclosure. The connector includes a connector housing and a connector terminal 30 arranged in the connector housing. In this example, the end cap 20 and the body 40 of the connector housing are similar to the end cap 20 and the body 40 of the connector housing disclosed in the first example, and will not be repeated herein.

In this example, the connector terminal 30 includes a clamping part 31, a connecting part 32, and a contacting part 33, as shown in FIGS. 4 and 5. Specifically, a second end 312 of the clamping part 31 is coupled to the contacting part 33 via the connecting part 32.

As shown in FIG. 4, at least one side of a first end 311 of the clamping part 31 is provided with a first barb structure 3112. Two sides of the second end 312 of the clamping part 31 are respectively provided with second barb structures 314. The contacting part 33 extends along a first direction and is configured for electrically contacting a terminal (not shown in the figure) paired with the connector terminal 30.

In addition, the clamping part 31 is further provided with a slot 313, as shown in FIG. 4. The slot 313 has a blade-type inner wall used for piercing an insulating casing of the cable, so as to achieve electrical connection between the cable and the connector terminal 30.

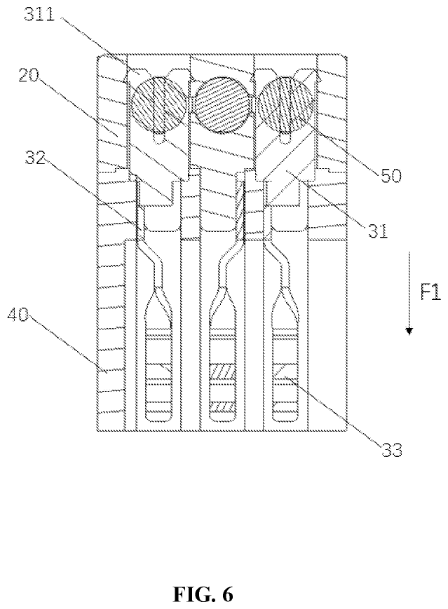

Meanwhile, the first end 311 of the clamping part 31 forms two first barb structures 3112, respectively, as shown in FIGS. 4 and 6. A cross section of each first barb structure 3112 in a direction perpendicular to the first direction F1 is triangular, so that the width of the first end 311 of the clamping part 31 is greater than the width of a first snapping groove 24 of the connector housing fitting with the connector terminal 30.

In this example, a cross section of the second barb structure 314 in a direction perpendicular to the first direction F1 is triangular, so that the width of the connecting part 32 in this direction is greater than the width of a second snapping groove 42 of the connector housing fitting with the connector terminal 30.

Furthermore, in actual use, the one or more first barb structures 3112 of the first end 311 of the clamping part 31 may be multiple triangles arranged along the first direction F1, that is, the first barb structure 3112 is serrated.

In this example, one side of the first barb structure 3112 extends obliquely from the top of the first end 311 of the clamping part 31 along a first angle. Specifically, the first angle refers to an angle between the side of the first barb structure 3112 and the first direction F1, and has an angle range of 15° to 45°.

Further, in this example, one side of the second barb structure 314 extends obliquely from the second end 312 of the clamping part 32 along a second angle. Specifically, the second angle refers to an angle between the side of the second barb structure 314 and the first direction F1, and has an angle range of 15° to 45°.

In this example, two sides of the first end 311 of the connector terminal 30 are respectively provided with the first barb structures 3112, as shown in FIG. 4. However, it is also applicable in actual use that only one side of the first end 311 is provided with the first barb structure 3112 as needed, or two sides of the first end 311 of the connector terminal 30 may be respectively provided with the first barb structures 3112 of different shapes as needed (for example, one side of the first end 311 of the connector terminal 30 is provided with the first barb structure 3112 having a triangular cross section, and the other side of the first end 311 of the connector terminal 30 is provided with the first barb structure 3112 having a serrated cross section).

In this example, the installation and matching process of the connector is similar to the first example, and only the differences between the two are described herein. The connector terminal 30 is first inserted into the body 40 of the connector housing so that the second barb structure 314 of the clamping part 31 of each connector terminal 30 has an interference fit with the second snapping groove 42 of the body 40, thereby ensuring a tight fit between the connector terminal 30 and the body 40.

Thus, the connector terminal 30 is closely fitted with the body 40 and the end cap 20 by means of the first barb structure 3112 and the second barb structure 314, and the body 40 and the end cap 20 are also closely fitted with each other by means of the first barb structure 3112 and the second barb structure 314.

The technical effect of the connector disclosed in the present example is similar to that of the first example, and the connectors disclosed in both examples can reduce the complexity of structure of the connector while improving the retention force of the connector, thereby reducing the manufacturing cost.

The above descriptions are merely embodiments of the present disclosure and are not intended to limit the embodiments of the present disclosure, and those skilled in the art may make various modifications and variations to the embodiments of the present disclosure. Any modifications, equivalent substitutions or improvements made within the spirit and principle of the embodiments of the present disclosure shall fall within the scope of protection of the embodiments of the present disclosure.

What is claimed is:

1. A connector terminal for electrically connecting a cable, comprising:
a clamping part, a side of a first end of the clamping part has a first barb structure, and a pair of sides of a second end of the clamping part each have a second barb structure, the first end is opposite to the second end; and
a contacting part extending along a first direction from the second end of the clamping part and electrically contacting a terminal paired with the connector terminal.

2. The connector terminal according to claim 1, wherein the clamping part has a slot and the cable is clamped in the slot.

3. The connector terminal according to claim 2, wherein the slot has a blade-type inner wall piercing an insulating casing of the cable and forming an electrical connection between the cable and the connector terminal.

4. The connector terminal according to claim 1, wherein a cross section of the first barb structure is triangular, a width of the first end of the clamping part is greater than a width of a first snapping groove of a connector housing fitting with the connector terminal.

5. The connector terminal according to claim 1, wherein a cross section of the second barb structure is triangular, a width of the second end of the clamping part is greater than a width of a second snapping groove of a connector housing fitting with the connector terminal.

6. The connector terminal according to claim 1, wherein a cross section of the first barb structure is a plurality of triangles arranged along the first direction, a width of the first end of the clamping part is greater than a width of a first snapping groove of a connector housing fitting with the connector terminal.

7. The connector terminal according to claim 4, wherein a side of the first barb structure extends obliquely from a top of the first end of the clamping part along a first angle, the first angle between the side of the first barb structure and the first direction has a range of 15° to 45°.

8. The connector terminal according to claim 5, wherein a side of the second barb structure extends obliquely from a bottom of the second end of the clamping part along a second angle, the second angle between the side of the second barb structure and the first direction has a range of 15° to 45°.

9. The connector terminal according to claim 4, wherein another side of the first end of the clamping part has the first barb structure.

10. A connector terminal for electrically connecting a cable, comprising:
a clamping part, a side of a first end of the clamping part has a first barb structure;
a connecting part coupled to a second end of the clamping part, an end of the connecting part has a second barb structure; and
a contacting part coupled to the connecting part and extending along a first direction, the contacting part electrically contacting a terminal paired with the connector terminal, the first end of the clamping part is opposite to the second end in the first direction.

11. The connector terminal according to claim 10, wherein the clamping part has a slot and the cable is clamped in the slot.

12. The connector terminal according to claim 11, wherein the slot has a blade-type inner wall piercing an insulating casing of the cable and forming an electrical connection between the cable and the connector terminal.

13. The connector terminal according to claim 10, wherein a cross section of the first barb structure is triangular, a width of the first end of the clamping part is greater than a width of a first snapping groove of a connector housing fitting with the connector terminal.

14. The connector terminal according to claim 10, wherein a cross section of the second barb structure is triangular, a width of the connecting part in a third direction is greater than a width of a second snapping groove of a connector housing fitting with the connector terminal.

15. The connector terminal according to claim 10, wherein a cross section of the first barb structure is a plurality of triangles arranged along the first direction, a width of the first end of the clamping part is greater than a width of a first snapping groove of a connector housing fitting with the connector terminal.

16. The connector terminal according to claim 13, wherein a side of the first barb structure extends obliquely from a top of the first end of the clamping part along a first angle, the first angle between the side of the first barb structure and the first direction has a range of 15° to 45°.

17. The connector terminal according to claim 14, wherein a side of the second barb structure extends obliquely from an end of the connecting part along a second angle, the second angle between the side of the second barb structure and the first direction has a range of 15° to 45°.

18. The connector terminal according to claim 13, wherein another side of the first end of the clamping part has the first barb structure.

19. A connector housing, comprising:
a body internally having a second snapping groove, a part of a connector terminal is arranged in the second snapping groove, the connector terminal including a clamping part and a contacting part, a side of a first end of the clamping part has a first barb structure and a pair of sides of a second end of the clamping part each have a second barb structure, the first end is opposite to the second end, the contacting part extends along a first direction from the second end of the clamping part; and
an end cap coupled to the body and internally having a first snapping groove, another part of the connector terminal is arranged in the first snapping groove.

20. The connector housing according to claim 19, wherein the body has:
a first housing internally having the second snapping groove, the second snapping groove has an interference fit with the second barb structure;
a pair of guide parts extending along a second direction from a top of a pair of opposite sides of the first housing, the second direction is opposite to the first direction; and
a snapping part arranged on a third side of the first housing, the third side is adjacent to the pair of guide parts.

21. The connector housing according to claim 20, wherein the end cap has:
a second housing internally having the first snapping groove, the first snapping groove has an interference fit with the first barb structure;
a pair of guide grooves arranged on a pair of sides of the second housing so that the guide grooves fit with the guide parts; and
a pair of snapping fitting parts arranged at a pair of lower ends of the sides of the second housing so that the snapping fitting parts firmly fit with the snapping part.

22. The connector housing according to claim 21, wherein the second housing internally has a cable groove receiving a cable electrically connected with the connector terminal.

23. A connector, comprising:
a connector terminal including a clamping part and a contacting part, a side of a first end of the clamping part has a first barb structure and a pair of sides of a second end of the clamping part each have a second barb structure, the first end is opposite to the second end, the contacting part extends along a first direction from the second end of the clamping part and electrically contacts a terminal paired with the connector terminal; and
a connector housing having a body internally having a second snapping groove and an end cap coupled to the body and internally having a first snapping groove, a part of the connector terminal is arranged in the second snapping groove and another part of the connector terminal is arranged in the first snapping groove.
